(19) United States
(12) Patent Application Publication
(10) Pub. No.: US 2009/0134084 A1
(43) Pub. Date: May 28, 2009

(54) Chlorinator system for wastewater treatment systems

(76) Inventor: Michael R. Braden, Hempstead, TX (US)

Correspondence Address: CRAIN, CATON & JAMES, FIVE HOUSTON CENTER, 1401 MCKINNEY, 17TH FLOOR, HOUSTON, TX, 77010, US

(21) Appl. No.: 12/364,636

(22) Filed: Feb. 3, 2009

Related U.S. Application Data
(63) Continuation-in-part of application No. 11/684,356, filed on Mar. 9, 2007.

(51) Int. Cl. C02F 1/76

(52) U.S. Cl. 210/198.1

(57) ABSTRACT

A chlorinator for wastewater treatment systems having a circulation pump, circulation tank, and return flow line, which includes a reservoir of disinfectant fluid and a dosage container communicating with the reservoir, and a siphon communicating with the return flow line and dosage contain to dispense a determined quantity of disinfectant to the circulation tank after operation of the circulation pump. The dosage container is vented to atmosphere to prevent vacuum lock in operation and communicates with the reservoir at a flow rate substantially smaller than it communicates with the siphon. Operation of the circulation pump causes flow through the return line, inducing priming of a siphon for subsequent distribution of the quantity of disinfectant fluid into the circulation tank after operation of the circulation pump ceases, at which time disinfectant is drawn from the dosage container. As the dosage container outgoing flow rate far exceeds the dosage container incoming flow rate, once the disinfectant level drops below the point of communication between the dosage container and the circulation tank, no further disinfectant is drawn into the circulation tank. A near-uniform volume of disinfectant fluid is thereby supplied after each pump cycle.

### CROSS REFERENCE TO RELATED APPLICATIONS

This is a continuation-in-part of U.S. patent application Ser. No. 11/684,356, Chlorinator for wastewater treatment systems, filed Mar. 9, 2007.

### STATEMENT REGARDING FEDERALLY SPONSORED RESEARCH OR DEVELOPMENT

Not Applicable.

### BACKGROUND OF THE INVENTION

1. Field of the Invention

This invention related generally to chlorinators for wastewater treatment systems. More specifically, this invention is a chlorinator for wastewater treatment systems, which have a disinfectant chamber that permits a uniform volume of disinfectant to be used each cycle.

2. Description of the Related Art

Chlorinators, which use either solid or liquid disinfectants, are known to the prior art. Illustrative of chlorinators using solid disinfectants are U.S. Pat. No. 6,183,630 issued to Reeves on Feb. 6, 2001; U.S. Pat. No. 4,100,073 issued to Hopcroft on Jul. 11, 1978; U.S. Pat. No. 5,350,512 issued to Tang on Sep. 27, 1994; and U.S. Pat. No. 5,405,540 issued to Tang on Apr. 11, 1995. Illustrative of chlorinators using liquid disinfectants are U.S. Pat. No. 4,333,833 issued to Longley et. al. on Jun. 8, 1982; U.S. Pat. No. 4,019,983 issued to Mandt on Apr. 26, 1977 and U.S. Pat. No. 3,996,139 issued to Prince et al. on Dec. 7, 1976.

Chlorination is widely used as part of wastewater treatment systems. In practice, a disinfectant such as chlorine is introduced at a point in the wastewater treatment system after which sufficient time, either by flow into a storage tank or through a region of flow, occurs to permit the chlorine to effectively disinfect the contaminant-bearing wastewater. The amount of disinfectant added to the wastewater is referred to as the “dosage,” and is usually expressed as milligrams per liter (mg/l) or parts per million (ppm). The amount of disinfectant necessary to disinfect a particular volume of wastewater is referred to as the “demand.”

The reaction between the disinfectant and the contaminants is typically not instantaneous but is instead time dependent. In order to obtain adequate disinfection, the mixing of wastewater and disinfectant should be completed in the shortest time possible, ideally a fraction of a second. The amount of disinfectant remaining in the wastewater at the time of measurement is referred to as the “residual.” The residual is therefore determined by the demand subtracted from the dosage.

Prior art chlorinators, whether using a liquid or solid disinfectant, typically mix the disinfectant with the wastewater during the flow of wastewater through the wastewater treatment system. In the case of chlorinators using a solid disinfectant, such as those disclosed in U.S. Pat. No. 6,183,630 issued to Reeves on Feb. 6, 2001; U.S. Pat. No. 4,100,073 issued to Hopcroft on Jul. 11, 1978; U.S. Pat. No. 5,350,512 issued to Tang on Sep. 27, 1994; and U.S. Pat. No. 5,405,540 issued to Tang on Apr. 11, 1995, mixing occurs by wastewater flow about a plurality of disinfectant tablets. In such systems the disinfectant is mixed at a rate dependant on the surface area of the table in contact with the wastewater, the density of the wastewater and the flow rate of the wastewater, among other variables. In the case of chlorinators using a liquid disinfectant, such as U.S. Pat. No. 4,333,833 issued to Longley et. al. on Jun. 8, 1982 mixing occurs at a contactor in the flowline wherein disinfectant fluid is drawn from a reservoir by pressure differential. In such systems the amount of chlorine combined with the wastewater varies with the flow rate of the wastewater and wastewater density. Thus it would be beneficial to the prior art to provide a chlorinator that dispenses a uniform volume of chlorine.

Other chlorinators using liquid disinfectant are likewise known, such as those disclosed in U.S. Pat. No. 6,627,071 issued to Braden on Sep. 30, 2003 and U.S. Pat. No. 6,932,912 issued to Chaffin on Aug. 23, 2005. U.S. Pat. No. 6,627,071 issued to Braden teaches a chlorinator for wastewater treatment systems having a circulation pump and return flow line which includes a disinfectant container, rendered buoyant by a float, floating within a space internal to a tank wherein the buoyant container intakes a determined quantity of disinfectant fluid through a check valve, which terminates communication between the disinfectant container and tank during operation of a circulation pump. After cessation of the circulation pump, the check valve opens to reestablish the quantity of disinfectant fluid. As a result, operation is dependent on a functioning check value. U.S. Pat. No. 6,932,912 issued to Chaffin on Aug. 23, 2005 discloses a system which continuously supplies liquid disinfectant so long as the circulation pump is active and the volume of disinfectant can be withdrawn from a single disinfectant reservoir. Such unlimited, as a result of circulation pump action, or unknown, as a result of exhaustion of some unknown volume of disinfectant remaining in the disinfectant reservoir, may result in excessive or inadequate dosage of chlorine. It would therefore be an improvement to properly control the volume of chlorine dispensed.

Typical water treatment systems contain sequential chambers for elimination of solid waste, which would not be consumed by aerobic action, for aerobic treatment of the wastewater, for clarification of the wastewater and for storage of treated wastewater prior to disbursal to the environment by a sprinkler system. Disinfectant is mixed with the treated wastewater between clarification and disbursal. Disbursal of treated wastewater by a sprinkler or line output system is accomplished by mechanical pumping action. Such systems utilize a pump, which generates pressure in excess of that necessary for operation of the attached output system. As a result a pressure relief valve set to the necessary pressure is located in the pump line prior to exit from the pump tank. This valve permits return of a necessary amount of treated wastewater into the pump tank so as not to exceed the necessary output pressure. Return of treated wastewater into the pump tank creates a turbulent area within the treated wastewater in the pump tank.

In the case of those chlorinators which add disinfectant by use of the flow of wastewater through the wastewater treatment system, it is, in some cases, desirable to increase the contact time between the disinfectant and the wastewater, beyond that available during the pump cycle.

It would be therefore be an improvement to provide a chlorinator that dispenses a near uniform volume of chlorine into the pump tank, without need of an additional external power supply, with no moving parts, and between pump cycles.

### SUMMARY OF THE INVENTION

Accordingly, it is an object of the present invention to provide, inter alia, a chlorinator for aerobic waste treatment systems that dispenses a uniform volume of liquid disinfectant rapidly mixes the disinfectant fluid with the wastewater without the need for an additional power source beyond that in an existing wastewater treatment system, without moving parts, and between pump cycles.

Other objects of my invention will become evident throughout the reading of this application.

The invention is a chlorinator for waste treatment systems that is in functional attachment to a pump line in a pump tank, which dispenses a uniform volume of disinfectant fluid during each pump cycle, regardless of the duration of the cycle.

In one embodiment a pump, driven by the existing circulation pump, is attached to a dosage container via a disinfectant fluid line. The dosage container is vented to atmosphere to prevent vacuum lock in operation and communicates with the reservoir at a flow rate substantially smaller than it communicates with the circulation tank. When the pump activates, the volume of dosage container is emptied into the final chamber of the waste treatment system, which may be a clarification chamber or a holding or pump tank. The dosage container refills at such a slow rate that little additional disinfectant may be withdrawn to the circulation tank.

Alternatively, the invention may include a discharge pump located in the final chamber of the waste treatment system to operate at a pressure greater than the system's sprinklers or lines, and a pressure relief valve such that when the discharge pump activates, the pressure relief valve opens and diverts from flow to return line. A siphon system may be placed in-line with the return line such that flow through the return line primes the siphon and cessation of flow through the return line activates the siphon and creates a vacuum in the disinfectant fluid line. The disinfectant fluid line passes through dosage container vent to terminate in the reservoir container. The dosage container communicates with the reservoir container via a passage located in the vent or on the surface of the dosage container.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

So that the manner in which the described features, advantages and objects of the invention, as well as others which will become apparent, are attained and can be understood in detail, more particular description of the invention briefly summarized above may be had by reference to the embodiments thereof that are illustrated in the drawings, which drawings form a part of this specification. It is to be noted, however, that the appended drawings illustrate only typical preferred embodiments of the invention and are therefore not to be considered limiting of its scope as the invention may admit to other equally effective embodiments.

FIG. 1 is a schematic diagram of a typical three chamber septic system.

FIG. 2 is a partial cut-away side view of the wastewater treatment system pump tank of the present invention.

FIG. 3 is a partial cut-away side view of the exemplary.

FIG. 4 is a partial cut-away side view of an alternative chlorinator.

FIG. 5 is a cross-sectional side view of illustrating the siphon for the present invention.

### DETAILED DESCRIPTION OF THE PREFERRED EMBODIMENT

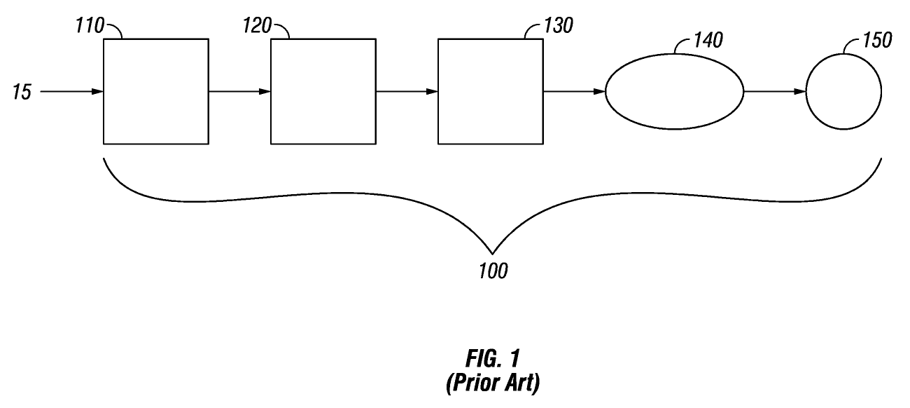

As shown in FIG. 1, a typical water treatment system 100 contains a series of steps that prepares wastewater 15 for release into the environment. The exemplary water treatment system 100 has a solid waste elimination chamber 110, an aerobic treatment chamber 120, a clarification and pump tank chamber 130, a chlorine addition step 140 and a disbursal step 150. In an alternative water treatment system (not shown), the clarification and pump tank chamber 130 may be divided among a clarification chamber and a pump tank. This invention addresses the chlorine addition step 140.

The chlorinator of the present invention includes a disinfectant reservoir container adapted to contain a volume of disinfectant fluid therein, a dosage container designed contain a specific dosage of disinfectant received from the disinfectant reservoir container and to vent after disbursal of that dosage per cycle, and a siphon primed by a connection to a return line and drawing disinfectant from the dosage container through a disinfectant fluid line for introduction to the pump tank.

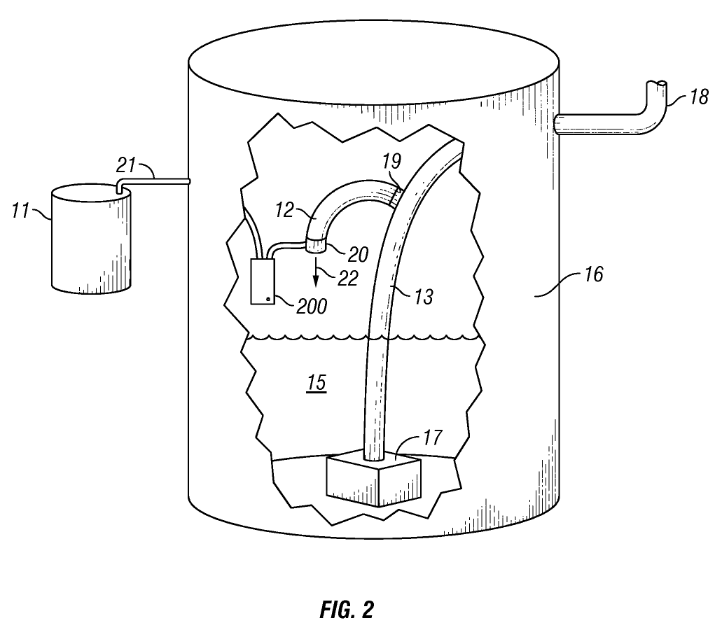

As shown in FIG. 2, the chlorinator 11 includes a siphon 200 and, while in use, disburses a uniform volume of a disinfectant fluid 14 (not shown) through a disinfectant fluid line 21 and a siphon 200 to the wastewater 15 in the pump tank 16. The disinfectant fluid line 21 therefore has a dosage container end and a siphon end. The pump tank 16 provides storage for wastewater 15 prior to being pumped by a pump 17 to the output 18. The pump 17 transmits wastewater 15 at a pressure higher than necessary for the output 18, which may be lines or a sprinkler system. A pressure relief valve 19 in the pump line 13 releases a sufficient volume of wastewater 15 into the flow return line 12 to prevent damage to the output 18 due to excessive pressure. The pump 17 operates on an intermittent basis. The pump 17 is activated either by timer or by the level of wastewater 15 and operates until the termination of the time cycle or until wastewater falls below a specific level in the pump tank 16. At all times during operation of the pump 17 some portion of wastewater 15 is diverted by the pressure relief valve 19 to the flow return line 12 as return wastewater 22. A siphon 200 is connected to the return line 12 and communicates with both the flow return line 12 and the chlorinator 11 such that the siphon 200 is primed, but prevented from operating, by the flow of return wastewater 22 through the low return line 12. Thus, when the pump 17 ceases operation, the siphon 200 may activate and draw the disinfectant, up to the maximum permitted dosage, for introduction to the wastewater 15.

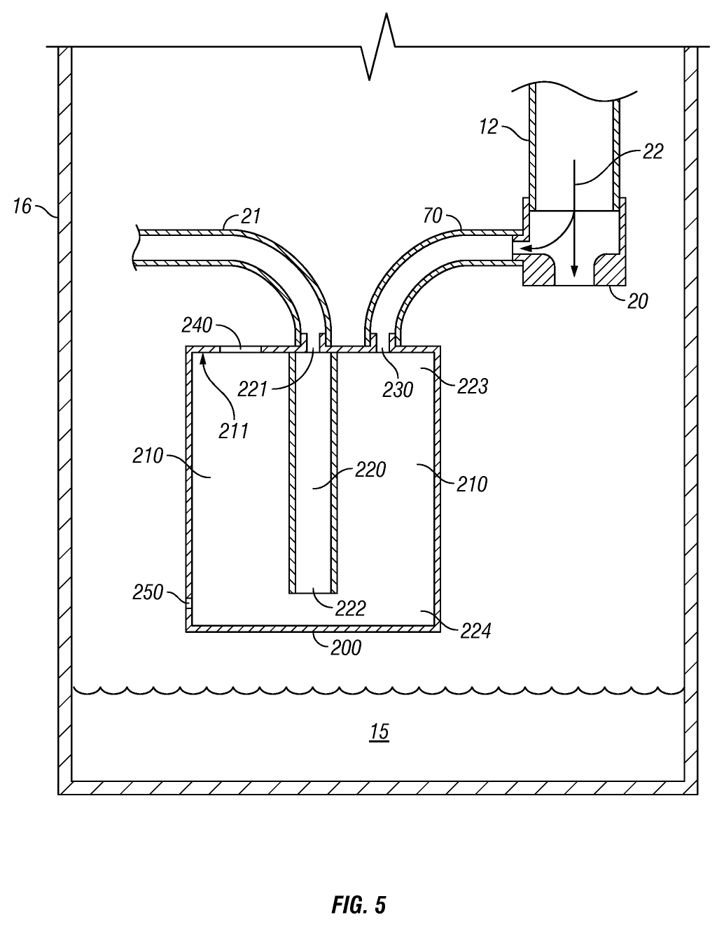

Disinfectant fluid 14 is drawn from the chlorinator 11 after operation of the pump 17 by use of a siphon 200 constructed to operate only after cessation of operation of the pump 17. Referring to FIG. 2 and FIG. 5, in the exemplary embodiment, the siphon connection 20 communicates with a flow-primed siphon 200 via a siphon connection line 70. The siphon connection 20 diverts a portion of return wastewater 22 to the siphon 200. A flow-primed siphon 200 is constructed to induce a siphoning action, and therefore a vacuum, only after the pump 17 has ceased operation and return wastewater 22 flows into the siphon 200 at a rate less than the flow rate through a drain 250 in the siphon 200. The flow-primed siphon 200 includes a first chamber 210, which includes a second, internal chamber 220 which is attached to the top inner surface 211 of the first chamber 210 and which descends into the first chamber 210. The second, internal chamber 220 is in fluid communication with the first chamber 210 at the bottom orifice 222 located at the lower end 224 of the second chamber 220. The second chamber 220 is in fluid communication with the disinfectant fluid line 21 through a narrow opening 221 at the upper end 223 of the second chamber 220. Thus, the disinfectant line 21 is in fluid communication with the siphon 200. The flow-primed siphon 200 further includes an inlet 230, and a vent 240 and a drain 250. In the preferred embodiment, vent 240 also functions as an outlet for overflow of the return wastewater 22 in the siphon 200. Vent 240 may also be a one-way valve, permitting the exit of air and return wastewater 22 from the siphon, but generating a vacuum in the siphon 200 once the siphon 200 is filled with return wastewater 22 and the drain 250 begins permitting fluid to exit the siphon 200. When vent 240 is a one-way valve, second, inner chamber 220 may be omitted from siphon 200. In the preferred embodiment the inlet 230, the narrow opening 221 and the vent/outlet 240 are positioned at, near or proximate the upper end 223 of the first chamber 210 while the drain 250 is positioned at, near or proximate the lower end 224 of the first chamber 210. While the inlet 230 need not be positioned near or proximate the upper end 223 of the first chamber 210, the vent/outlet 240 should be positioned near or proximate the upper end 223 of the first chamber 210 to ensure priming of the siphon 200. The inlet 230 is in fluid communication with the siphon connection line 70 and the return line 12 while the vent/outlet 240 communicates to the pump tank 16. The inlet 230 and the vent/outlet 240 are sized equivalent to the siphon connection line 70 to ensure no restriction in flow from the siphon connection line 70. The drain 250, however, is sized less, preferably substantially less, than vent/outlet 240. In operation, the pump 17 is engaged by the wastewater treatment system 100, returning a volume of water to the pump tank 16 via the return line 12, which is in fluid communication with the flow-primed siphon 200. In the preferred embodiment, only a portion of the volume of water through the return line 12 is diverted, so as to prime the siphon 200 without creating a level of backpressure from the siphon 200 into the return line 12, which would frustrate operation of the pressure relief valve 19. However, the drain 250 and the vent/outlet 240 could be sized to permit the entirety of the volume of water to be diverted through the return line 12. As water from the siphon connection line 70 enters the first chamber 210, it fills the first chamber 210 and the second, inner chamber 220, then exits the flow-primed siphon 200 via the vent/outlet 240. The second, inner chamber 220 is sized to create a siphoning effect, so after the pump 17 has ceased operation and return wastewater 22 flows into the siphon 200 at a rate less than the flow rate through the drain 250 in the siphon 200 and the water drains from the first chamber 210 through the drain 250, the height of water in the second, inner chamber 220 creates a siphon on the disinfectant fluid line 21, drawing the disinfectant 14 from the chlorinator 11 into the second, inner chamber 220 to be drained into the pump tank 16 via the drain 250. Once the water drains below the second, inner chamber 220 in first chamber 210, the siphon 200 ceases operation and no further disinfectant fluid 14 is drawn, assuming the chlorinator 11 has not vented to air by that time and terminated the siphon effect.

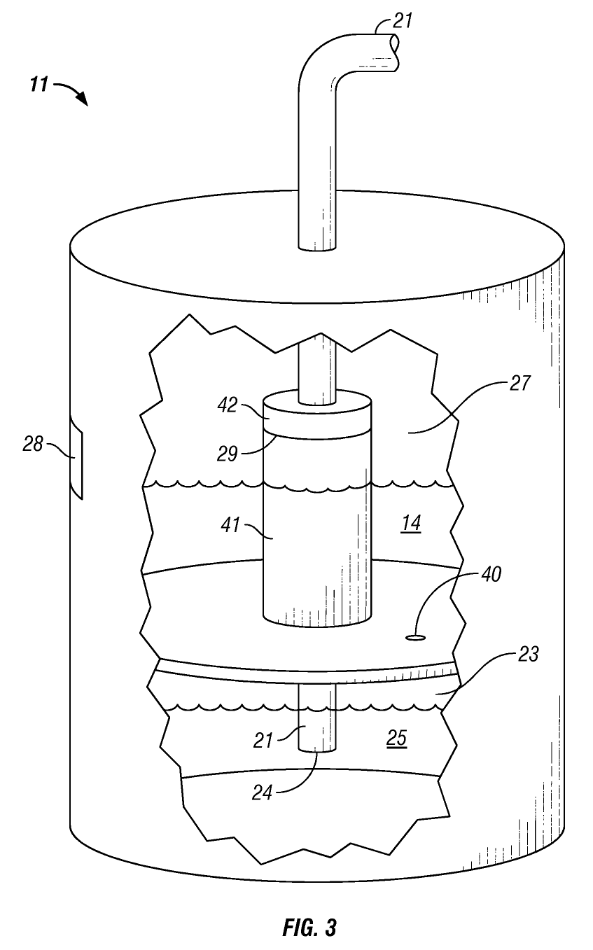

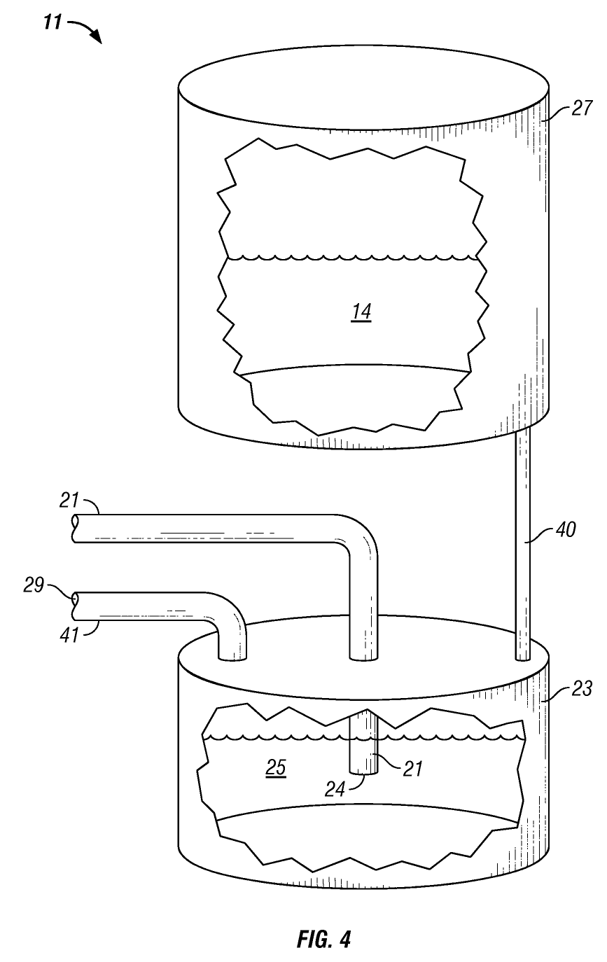

Referring to FIGS. 2, 3, and 4 when the siphon 200 is active, disinfectant fluid 14 is withdrawn from the chlorinator 11. In the exemplary embodiment the flow-primed siphon 200 draws disinfectant fluid 14 through the disinfectant fluid line 21, which terminates in the dosage container 23. The disinfectant fluid line 21 is thus in fluid communication with the dosage container 23. When the portion of the fluid disinfectant volume 25 above the bottom orifice 24 of the disinfectant fluid line 21 is withdrawn, the chlorinator 11 ceases to supply additional disinfectant fluid 14 and instead supplies air, which is drawn from the reservoir container 27 via the chlorinator vent 41. As depicted in FIG. 3, the chlorinator vent 41 may be located to pass through the reservoir container 27, and may then have a valve or float 42 to prevent fluid communication to the dosage container 23 from the reservoir container 27. Preferably where the chlorinator vent 41 passes through the reservoir container 27, the reservoir container 27 has an overfill exit 28 or other apparatus known in the art to prevent the filling of the reservoir container 27 above the top 29 of the chlorinator vent 41. Thus, the chlorinator vent 41 is in communication with the dosage container 23. In the exemplary embodiment, as the dosage container 23 draws air from within the chlorinator 11, which is relatively saturated with disinfectant gas, thereby possessing less capacity to degrade the disinfectant fluid with which it comes in contact. Alternatively, as depicted in FIG. 4, the chlorinator vent 41 may be located to pass to atmosphere.

In the preferred embodiment, the disinfectant fluid line 21 communicates with the dosage container 23 by passing through the chlorinator vent 41, which passes through the reservoir container 27.

The fluid disinfectant volume 25 is replenished via the dosage passageway 40. The dosage passageway 40 is sized that the flow rate of the disinfectant fluid 14 through the disinfectant fluid line 21 during operation of the pump 17 so far exceeds the flow rate of the disinfectant fluid 14 through the dosage passageway 40 that the additional inflow of the disinfectant fluid 14 during operation of the pump 17 is negligible compared to the total volume of the disinfectant fluid 14. The dosage passageway 40 provides fluid communication between the dosage container 23 and the disinfectant reservoir container 27. In the preferred embodiment, the disinfectant fluid line 21 is at least five times the cross sectional area of the dosage passageway 40. The dosage passageway 40 may be located at the interface between the reservoir container 27 and the dosage container 23, or through the chlorinator vent 41 where the chlorinator vent 41 passes through the reservoir container 27. Alternatively, the dosage passageway 40 may be piping connecting the reservoir container 27 and the dosage container 23.

There is essentially no increase in the volume of the disinfectant fluid 25 during operation of the siphon 200. Once the level of the fluid disinfectant 14 drops below the bottom orifice 24 of the disinfectant fluid line 21, no further disinfectant fluid 14 is drawn into the circulation tank.

The volume withdrawn during operation of the chlorinator 11 may be adjusted by resizing of the dosage container 23 or by adjustment of the location of the bottom orifice 24 of disinfectant fluid line 21. A smaller dosage container 23 or positioning of the bottom orifice 24 of the disinfectant fluid line 21 higher in the dosage container 23 will result in less disinfectant being added per cycle of the siphon 200. Likewise a larger dosage container 23 or positioning of the bottom orifice 24 of the disinfectant fluid line 21 lower in the dosage container 23 will result in more disinfectant being added per cycle of the siphon 200.

In operation, the chlorinator vent 41 may be removably attached to the dosage container 23, preferably by a threaded connection. Likewise, the reservoir container 27 may be sized to accept a dosage container 23 via a press-fit at its lower-most point.

The terms and expressions which have been employed in the foregoing specification are used therein as terms of description and not of limitation, and there is no intention, in the use of such terms and expressions, of excluding equivalents of the features shown and described or portions thereof.

I claim:

1. A chlorinator for a wastewater treatment system,
said wastewater treatment system having a discharge pump, a pressure relief valve, and a pump tank;
said pressure relief valve communicating with a return line,
said chlorinator comprising:
a disinfectant reservoir container adapted to contain a volume of disinfectant fluid therein;
a dosage container;
a siphon operably connectable to said return line, said siphon comprising
a first chamber, said first chamber having an inlet, a vent, and a drain, said first chamber having an top inner surface, said first chamber having a upper end and a lower end, said drain positioned proximate said first chamber lower end, said vent position proximate said first chamber upper end, said inlet adapted for fluid communication with said return line, said vent adapted for communication with said pump tank;
a second chamber, said second chamber internal said first chamber and in fluid communication with said first chamber and attached to said top inner surface of said first chamber and descending downwardly into said first chamber, said second chamber having a lower end, said second chamber having an opening at said second chamber lower end, said second chamber having an upper end, said second chamber having an opening at said second chamber upper end, said second chamber adapted for fluid communication with a fluid disinfectant line through said opening; said second chamber sized to siphon said fluid disinfectant from said fluid disinfectant line during drainage of first chamber through said drain;
said disinfectant fluid line having a dosage container end and a siphon end, said disinfectant fluid line in fluid communication with said dosage container and in fluid communication with said siphon;
said dosage container in fluid communication of said disinfectant reservoir container via a dosage passageway; and
a vent, said vent in communication with said dosage container.

2. The chlorinator of claim 1 wherein:
said dosage passageway is located in said vent.

3. The chlorinator of claim 2 wherein:
said disinfectant fluid line having a minimum cross-sectional area;
said dosage passageway having a minimum cross-sectional area; and
said minimum cross-sectional area of said disinfectant fluid line being at least five times said minimum cross-sectional area of said dosage passageway.

4. The chlorinator of claim 3 wherein:
said vent being removably attached to said dosage container.

5. The chlorinator of claim 3 wherein:
said vent communicating with said reservoir container above said volume of disinfectant fluid.

6. The chlorinator of claim 1 wherein:
said dosage passageway is located in said vent.

7. The chlorinator of claim 6 wherein:
said disinfectant fluid line having a minimum cross-sectional area;
said dosage passageway having a minimum cross-sectional area; and
said minimum cross-sectional area of said disinfectant fluid line being at least five times said minimum cross-sectional area of said dosage passageway.

8. The chlorinator of claim 7 wherein:
said vent being removably attached to said dosage container.

9. The chlorinator of claim 8 wherein:
said vent communicating with said reservoir container above said volume of disinfectant fluid.

10. The chlorinator of claim 1 wherein:
said disinfectant fluid line having a minimum cross-sectional area;
said dosage passageway having a minimum cross-sectional area; and
said minimum cross-sectional area of said disinfectant fluid line being at least five times said minimum cross-sectional area of said dosage passageway.

11. The chlorinator of claim 10 wherein:
said vent being removably attached to said dosage container.

12. The chlorinator of claim 11 wherein:
said vent communicating with said reservoir container above said volume of disinfectant fluid.

13. A chlorinator for a wastewater treatment system,
said wastewater treatment system having a discharge pump, a pressure relief valve, and a pump tank;
said pressure relief valve communicating with a return line,
said chlorinator comprising:
a disinfectant reservoir container adapted to contain a volume of disinfectant fluid therein;
a dosage container, said dosage container in fluid communication of said disinfectant reservoir container via a dosage passageway;
a siphon adapted for communication with said return line and adapted to siphon from said dosage container and to drain to said pump tank; and
a vent, said vent in communication with said dosage container.

14. The chlorinator of claim 13 wherein:
said dosage passageway is located in said vent.

15. The chlorinator of claim 14 wherein:
said disinfectant fluid line having a minimum cross-sectional area;
said dosage passageway having a minimum cross-sectional area; and
said minimum cross-sectional area of said disinfectant fluid line being at least five times said minimum cross-sectional area of said dosage passageway.

16. The chlorinator of claim 15 wherein:
said vent being removably attached to said dosage container.

17. The chlorinator of claim 15 wherein:
said vent communicating with said reservoir container above said volume of disinfectant fluid.

18. The chlorinator of claim 13 wherein:
said dosage passageway is located in said vent.

19. The chlorinator of claim 18 wherein:
said disinfectant fluid line having a minimum cross-sectional area;
said dosage passageway having a minimum cross-sectional area; and
said minimum cross-sectional area of said disinfectant fluid line being at least five times said minimum cross-sectional area of said dosage passageway.

20. The chlorinator of claim 19 wherein:
said vent being removably attached to said dosage container.

21. The chlorinator of claim 20 wherein:
said vent communicating with said reservoir container above said volume of disinfectant fluid.

22. The chlorinator of claim 13 wherein:
said disinfectant fluid line having a minimum cross-sectional area;
said dosage passageway having a minimum cross-sectional area; and
said minimum cross-sectional area of said disinfectant fluid line being at least five times said minimum cross-sectional area of said dosage passageway.

23. The chlorinator of claim 22 wherein:
said vent being removably attached to said dosage container.

24. The chlorinator of claim 23 wherein:
said vent communicating with said reservoir container above said volume of disinfectant fluid.
